(19) United States
(12) Patent Application Publication
(10) Pub. No.: US 2011/0104971 A1
(43) Pub. Date: May 5, 2011

(54) Fibrous article with fabric-like surface and process of manufacturing same

(76) Inventors: Shui Yuan Ma, Taipei (TW); Ling-Ling Cheng, Taipei (TW)

(21) Appl. No.: 12/608,003

(22) Filed: Oct. 29, 2009

(51) Int. Cl. B32B 27/04; B29C 31/00

(52) U.S. Cl. 442/64; 264/152

(57) ABSTRACT

A fibrous article having a fabric-like surface and process of manufacturing same are provided. The fibrous article includes an outer fabric substrate; an intermediate fiber substrate; and an inner thermoplastic resin layer. A first thermoplastic resin is formed between the fabric substrate and the fiber substrate. The first thermoplastic resin is further formed between the fiber substrate and the thermoplastic resin layer. The thermoplastic resin layer is formed by injection molding by causing a second thermoplastic resin to react with the first thermoplastic resin. A person may have the feeling of touching fabric when touches the fibrous article.

### BACKGROUND OF THE INVENTION

1. Field of Invention

The invention relates to fibrous article manufacturing processes and more particularly to a fibrous article with fabric-like surface and process of manufacturing same with improved characteristics including simplified process, reduced weight, increased structural strength, and being aesthetic.

2. Description of Related Art

Plastic products are widely used in our daily life. Moreover, a plastic article having a visually attractive surface is always desired. Therefore, techniques of manufacturing a plastic article having an aesthetic surface have been developed.

A conventional process of manufacturing a plastic fibrous article having a smooth surface comprises coating an appropriate material on a half-finished article.

The above and other known techniques suffer from several disadvantages. For example, they are complicated and expensive. Thus, the need for improvement still exists.

### SUMMARY OF THE INVENTION

It is therefore one object of the invention to provide a process of manufacturing a fibrous article having a fabric-like surface.

It is another object of the invention to provide a fibrous article having a fabric-like surface.

The above and other objects, features and advantages of the invention will become apparent from the following detailed description taken with the accompanying drawings.

### BRIEF DESCRIPTION OF THE DRAWINGS

FIG. 1 is a flowchart depicting a process of manufacturing a fibrous article with a fabric-like surface according to a preferred embodiment of the invention;

FIG. 2 is a longitudinal sectional view of a first thermoplastic resin layer formed on a bottom of a fabric substrate to be secured to a continuous fiber substrate having a second thermoplastic resin layer formed on each of bottom and top respectively;

FIG. 3 is a longitudinal sectional view of the secured fabric substrate and the continuous fiber substrate of FIG. 2;

FIG. 4 is a perspective view of an open container shaped half-finished article having the layered structure shown in FIG. 3; and

FIG. 5 is a perspective view of an open container shaped finished article after subjecting the half-finished article to injection molding.

### DETAILED DESCRIPTION OF THE INVENTION

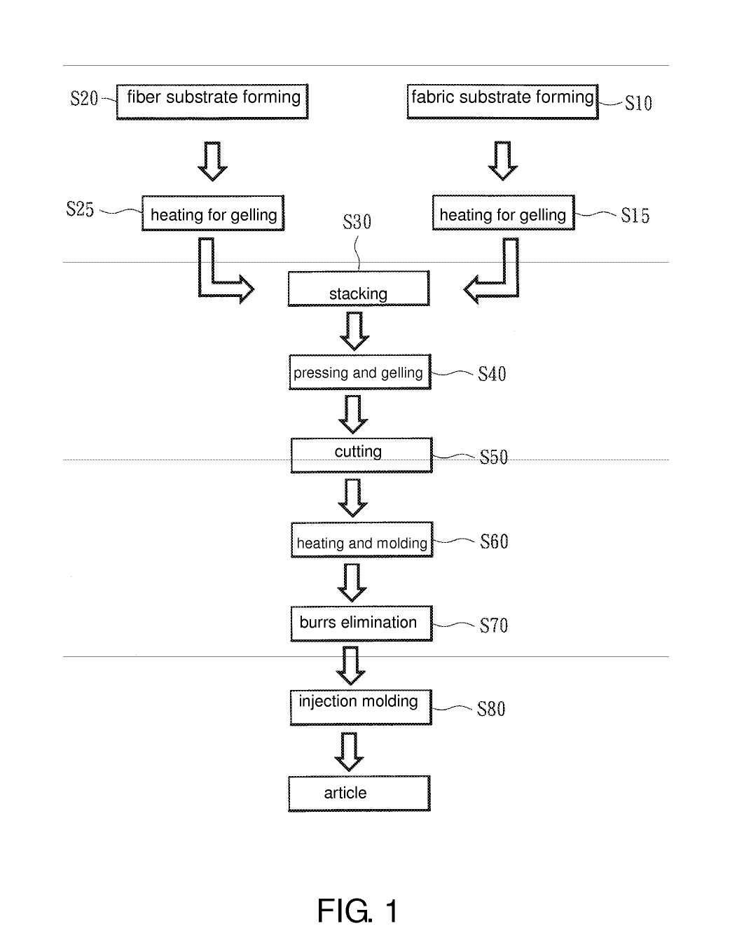

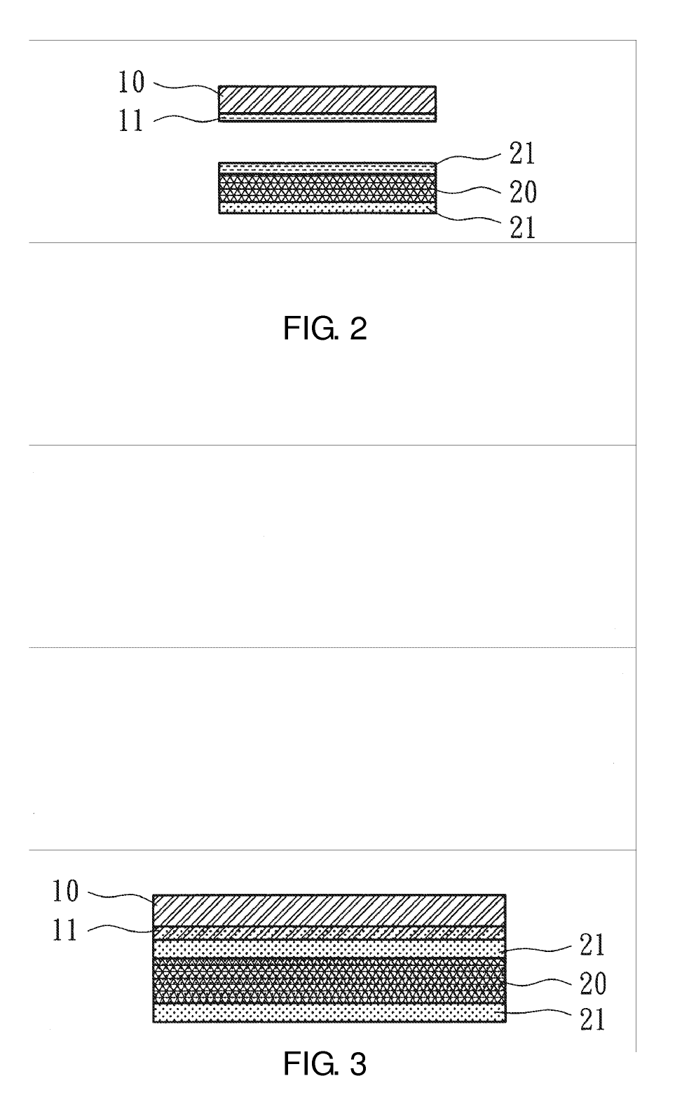

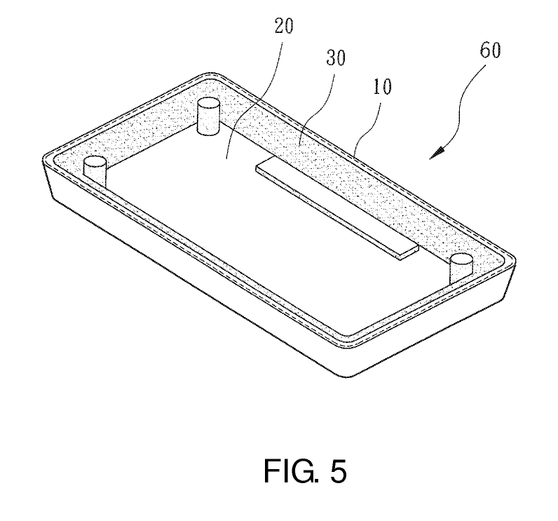

Referring to FIG. 1 in conjunction with FIGS. 2 to 5, a flowchart depicting a process for manufacturing a fibrous article with a fabric-like surface according to a preferred embodiment of the invention is illustrated. The process comprises the following steps:

In step S10, a first thermoplastic resin layer 11 is formed on a bottom surface of fabric substrate 10 by submerging the fabric substrate 10 in a bath of first thermoplastic resin. Alternatively, the first thermoplastic resin layer 11 is formed by coating a first thermoplastic resin on the bottom surface of the fabric substrate 10 in other embodiments. Material of the fabric substrate 10 is selected from the group consisting of fabric, cloth, bamboo, wood, natural leather, and artificial leather. Material of the first thermoplastic resin layer 11 is selected from the group consisting of ABS (acrylonitrile butadiene styrene), PS (polystyrene), PC (polycarbonate), PE (polyethylene), AS (acrylonitrile styrene), PMMA (polymethyl methacrylate), PET (polyethylene terephthalate), PA (polyamide), PBT (polybothlene terephalate), PEEK (polyether ether ketone), and PEI (polyetherimide).

In step S15, the fabric substrate 10 and the first thermoplastic resin layer 11 are baked at a temperature of between about 60° C. and 80° C. until the first thermoplastic resin layer 11 becomes gel.

In step S20, a continuous fiber substrate 20 is conveyed by rollers to pass through a bath of second thermoplastic resin. The second thermoplastic resin permeates the continuous fiber substrate 20 and forms a second thermoplastic resin layer 21 on each of top and bottom surfaces of the continuous fiber substrate 20. Material of the continuous fiber substrate 20 is selected from the group consisting of carbon fiber, glass fiber, synthetic fiber, natural fiber, and asbestos. Material of the second thermoplastic resin layer 21 is selected from the group consisting of ABS, PS, PC, PE, AS, PMMA, PET, PA, PBT, PEEK, and PEI.

In step S25, the continuous fiber substrate 20 and the second thermoplastic resin layers 21 are baked at a temperature of between about 60° C. and 80° C. until the second thermoplastic resin layer 21 becomes gel.

Note that the steps S20 and S25 can be performed at the same time as the steps S10 and S15.

In step S30, the formed fabric substrate 10 and the first thermoplastic resin layer 11 are placed on the formed continuous fiber substrate 20 and the second thermoplastic resin layers 21.

In step S40, a hydraulic press machine is employed to press the fabric substrate 10 at a temperature of between about 25° C. and 150° C. until about 20% to 70% of the first thermoplastic resin in the first thermoplastic resin layer 11 permeates the fabric substrate 10 and about 20% to 70% of the second thermoplastic resin in the second thermoplastic resin layers 21 permeates the continuous fiber substrate 20 respectively. At the same time, the first thermoplastic resin layer 11 and the second thermoplastic resin layer 21 are further gelatinized. A continuous plate is produced (see FIG. 3).

In step S50, the continuous plate is cut into a plurality of units of predetermined size.

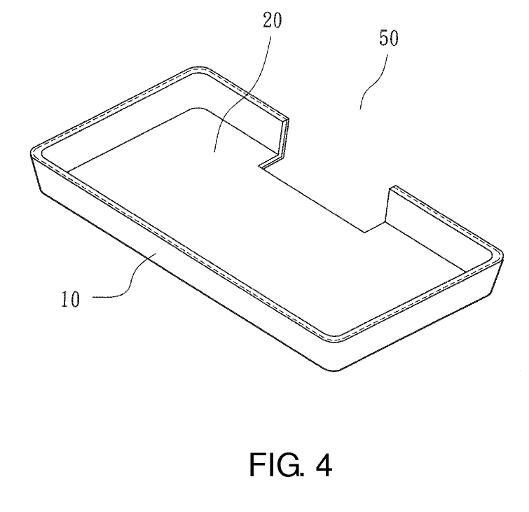

In step S60, a mold is heated to a temperature of between about 120° C. and 180° C. and the units are heated to a temperature of between about 180° C. and 230° C. respectively. Thereafter, the units are pressed into the mold and cooled to a temperature of between about 50° C. and 70° C. As a result, an open container shaped half-finished article 50 having a cut is produced (as shown in FIG. 4). Note that the half-finished article 50 may have other shapes such as a concave surface, a convex surface, or a bent shape.

In step S70, burrs and sharp edges of the half-finished article 50 are eliminated, for example, by means of CNC (computer numerical control).

In step S80, a second mold is employed to cooperate with the mold and both molds are subject to injection molding by employing a third thermoplastic resin. Material of the third thermoplastic resin is selected from the group consisting of ABS, PS, PC, PE, AS, PMMA, PET, PA, PBT, PEEK, and PEI. Alternatively, the material of the third thermoplastic resin is selected from the group consisting of ABS, PS, PC, PE, AS, PMMA, PET, PA, PBT, PEEK, PEI, and an alloy resin formed by adding an additive (e.g., at least one of talc, carbon fiber, and glass fiber) to any of ABS, PS, PC, PE, AS, PMMA, PET, PA, PBT, PEEK, and PEI. As a result, a third thermoplastic resin layer 30 is formed on an inner surface of the four sides of a finished article 60.

The finished article 60 of the invention has the characteristics of increased structural strength and a surface similar to that of a fabric. Moreover, the finished article 60 has the advantage of being aesthetic so that it can be used as container, cover, or the like. In addition, the invention can be mass produced easily.

While the invention herein disclosed has been described by means of specific embodiments, numerous modifications and variations could be made thereto by those skilled in the art without departing from the scope and spirit of the invention set forth in the claims.

What is claimed is:

1. A process of manufacturing a fibrous article comprising the steps of:
(a) forming a first thermoplastic resin layer on a bottom surface of a fabric substrate by submerging the fabric substrate in a bath of first thermoplastic resin;
(b) heating the fabric substrate and the first thermoplastic resin layer at a first temperature until the first thermoplastic resin layer becomes gel;
(c) passing a continuous fiber substrate through a bath of second thermoplastic resin so that the second thermoplastic resin permeates the continuous fiber substrate and forms a second thermoplastic resin layer on each of a top surface and a bottom surface of the continuous fiber substrate;
(d) heating the continuous fiber substrate and the second thermoplastic resin layers at a second temperature until the second thermoplastic resin layer becomes gel;
(e) placing the fabric substrate and the first thermoplastic resin layer on the continuous fiber substrate and the second thermoplastic resin layers;
(f) pressing the fabric substrate at a third temperature until a predetermined percentage of the first thermoplastic resin in the first thermoplastic resin layer permeates the fabric substrate and a predetermined percentage of the second thermoplastic resin in the second thermoplastic resin layers permeates the continuous fiber substrate respectively, and each of the first thermoplastic resin layer and the second thermoplastic resin layer is further gelatinized to form a continuous plate;
(g) cutting the continuous plate into a plurality of units;
(h) heating a first mold to a fourth temperature and heating the units to a fifth temperature respectively;
(i) pressing the units into the mold;
(j) cooling the mold to a sixth temperature to form a half-finished article; and
(k) subjecting a second mold and the first mold to injection molding by employing a third thermoplastic resin to produce the finished fibrous article having a third thermoplastic resin layer formed on a predetermined portion of an inner surface thereof.

2. The process of claim 1, wherein the fabric substrate is formed of a material selected from the group consisting of fabric, cloth, bamboo, wood, natural leather, and artificial leather.

3. The process of claim 1, wherein the continuous fiber substrate is formed of a material selected from the group consisting of carbon fiber, glass fiber, synthetic fiber, natural fiber, and asbestos.

4. The process of claim 1, wherein each of the first, second, and third thermoplastic resin layers is formed of a material selected from the group consisting of ABS (acrylonitrile butadiene styrene), PS (polystyrene), PC (polycarbonate), PE (polyethylene), AS (acrylonitrile styrene), PMMA (polymethyl methacrylate), PET (polyethylene terephthalate), PA (polyamide), PBT (polybothlene terephalate), PEEK (polyether ether ketone), and PEI (polyetherimide).

5. The process of claim 1, wherein the third thermoplastic resin layer is formed of a material selected from the group consisting of ABS, PS, PC, PE, AS, PMMA, PET, PA, PBT, PEEK, PEI, and an alloy resin formed by adding an additive to any of ABS, PS, PC, PE, AS, PMMA, PET, PA, PBT, PEEK, and PEI.

6. The process of claim 5, wherein the additive is selected from the group consisting of talc, carbon fiber, and glass fiber.

7. The process of claim 1, wherein each of the first and second temperature is in a range of 60° C. to 80° C.

8. The process of claim 1, wherein the third temperature is in a range of 25° C. to 150° C.

9. The process of claim 1, wherein the fourth temperature is in a range of 120° C. to 180° C.

10. The process of claim 1, wherein the fifth temperature is in a range of 180° C. to 230° C.

11. The process of claim 1, wherein the sixth temperature is in a range of 50° C. to 70° C.

12. The process of claim 1, further comprising the sub-step of eliminating burrs and/or sharp edges of the half-finished article after step (j).

13. The process of claim 1, wherein the predetermined percentage of the first thermoplastic resin in the first thermoplastic resin layer permeates the fabric substrate is in a range of 20% to 70% of the first thermoplastic resin in the first thermoplastic resin layer, and the predetermined percentage of the second thermoplastic resin in the second thermoplastic resin layers permeates the continuous fiber substrate is in a range of 20% to 70% of the second thermoplastic resin in the second thermoplastic resin layers.

14. A fibrous article comprising:
an outer fabric substrate;
an intermediate fiber substrate; and
an inner thermoplastic resin layer,
wherein a first thermoplastic resin is formed between the fabric substrate and the fiber substrate, the first thermoplastic resin is further formed between the fiber substrate and the thermoplastic resin layer, and the thermoplastic resin layer is formed by injection molding by causing a second thermoplastic resin to react with the first thermoplastic resin.

15. The fibrous article of claim 14, wherein the fabric substrate is formed of a material selected from the group consisting of fabric, cloth, bamboo, wood, natural leather, and artificial leather.

16. The fibrous article of claim 14, wherein the fiber substrate is formed of a material selected from the group consisting of carbon fiber, glass fiber, synthetic fiber, natural fiber, and asbestos.

17. The fibrous article of claim 14, wherein each of the first and second thermoplastic resins is selected from the group consisting of ABS (acrylonitrile butadiene styrene), PS (polystyrene), PC (polycarbonate), PE (polyethylene), AS (acrylonitrile styrene), PMMA (polymethyl methacrylate), PET (polyethylene terephthalate), PA (polyamide), PBT (polybothlene terephalate), PEEK (polyether ether ketone), and PEI (polyetherimide).

18. The fibrous article of claim 14, wherein the second thermoplastic resin is selected from the group consisting of ABS, PS, PC, PE, AS, PMMA, PET, PA, PBT, PEEK, PEI, and an alloy resin formed by adding an additive to any of ABS, PS, PC, PE, AS, PMMA, PET, PA, PBT, PEEK, and PEI.

19. The fibrous article of claim 18, wherein the additive is selected from the group consisting of talc, carbon fiber, and glass fiber.
